(19) United States
(12) Patent Application Publication
(10) Pub. No.: US 2006/0175949 A1
(43) Pub. Date: Aug. 10, 2006

(54) Plasma display panel and manufacturing method thereof

(76) Inventor: Jin Hee Jeong, Seongnam-si (KR)

Correspondence Address: MCKENNA LONG & ALDRIDGE LLP, 1900 K STREET, NW, WASHINGTON, DC, 20006, US

(21) Appl. No.: 11/221,860

(22) Filed: Sep. 9, 2005

(30) Foreign Application Priority Data
Feb. 4, 2005 (KR) 2005-10500

(51) Int. Cl. H01J 17/49

(52) U.S. Cl. 313/292; 313/582

(57) ABSTRACT

There are provided a plasma display apparatus and a manufacturing method thereof. A PDP according to a first embodiment of the present invention includes: row ribs and column ribs with a height different from that of the row ribs, wherein a permittivity of higher ones of the row ribs and the column ribs is lower than that of lower ones of the row ribs and the column ribs. A PDP according to a second embodiment of the present invention includes: row ribs and column ribs with a height different from that of the row ribs, wherein a permittivity of higher ones of the row ribs and the column ribs is lower than that of lower ones of the row ribs and the column ribs and the higher ribs are made of at least two materials with different permittivities. Also, the method for manufacturing the PDP, the PDP including discharge cells partitioned by row ribs and column ribs, wherein a method for forming the row ribs and the column ribs including: (a) forming a paste for the row ribs and the column ribs on a dielectric layer formed on a glass; (b) forming a pattern for forming the row ribs and the column ribs on the paste for the row ribs and the column ribs; and (c) forming a material having a permittivity lower than that of the paste for forming the column ribs, with a predetermined height on the column ribs.

### BACKGROUND OF THE INVENTION

1. Field of the Invention

The present invention relates to a plasma display panel (PDP), and more particularly, to a plasma display apparatus, a plasma display panel (PDP), and a manufacturing method thereof, capable of enhancing discharge efficiency by improving the structure of barrier ribs partitioning discharge cells of the PDP.

2. Description of the Related Art

Generally, in a plasma display panel (PDP), discharge cells are partitioned by barrier ribs formed between a front panel and a rear panel. Each discharge cell is filled with main discharge gas, such as Ne, He, or Ne—He mixture (Ne+He), and inert gas containing a small amount of Xe. When discharge occurs by a high frequency voltage, the inert gas generates vacuum ultraviolet rays and excites phosphors formed between the barrier ribs, thereby forming an image. Such a PDP currently is in the focus of attention as a next-generation display since it is thin in thickness and light in weight.

FIG. 1 is a perspective view of a conventional PDP 100. Referring to FIG. 1, in the conventional PDP 100, a front substrate including a front glass 10 on which scan electrodes 11 (11 for each) and sustain electrodes 12 (12 for each) are arranged is coupled spacing by a predetermined distance with a rear substrate including a rear glass 20 on which address electrodes 22 (22 for each) are arranged.

In the front substrate, each scan electrode 11 is comprised of a transparent electrode 11a and a bus electrode 11b, and each sustain electrode 12 is comprised of a transparent electrode 12a and a bus electrode 12b, wherein the transparent electrodes 11a and 12a are made of a transparent material, for example, ITO (Indium-Tin-Oxide) and the bus electrodes 11b and 12b are made of metal to reduce resistance. A upper dielectric layer 13a and a protection film 14 are sequentially formed on the front substrate 10 on which the scan electrodes 11 and the sustain electrodes 12 are arranged. Wall charges generated by plasma discharge are accumulated on the upper dielectric layer 13a. The protection film 14 accelerates the generation of secondary electrons as well as preventing the upper dielectric layer 13a from being damaged due to sputtering caused by plasma discharge. A MgO layer is generally used as the protection film 14.

In the rear substrate, a lower dielectric layer 13b and barrier ribs 21 (21 for each) are sequentially formed on the rear glass 20 on which the address electrodes 22 are arranged. Phosphor layers 23 (23 for each) are formed on the exposed surfaces of the lower dielectric layer 13b and the lateral surfaces of the barrier ribs 21. The address electrodes 22 are formed to orthogonally intersect the scan electrodes 11 and the sustain electrodes 12. The barrier ribs 21 are formed in parallel with the address electrodes 22 so to prevent ultraviolet rays and visible rays generated by discharge from being transmitted to adjacent discharge cells. The phosphor layers 23 are excited by ultraviolet rays generated by plasma discharge, so that visible light of red, green, or blue is emitted. Discharge spaces of the discharge cells partitioned by the barrier ribs 21 between the front substrate and the rear substrate are filled with inert gas mixture, such as He—Xe mixture and Ne—Xe mixture, to occur discharge.

Meanwhile, the barrier ribs 21 for forming a plurality of discharge spaces (that is, the discharge cells) over the rear substrate can be formed in a stripe type or in a well type.

The barrier ribs 21 can be designed in various types, considering brightness characteristic, gas discharge characteristic, and the application proportion of phosphor layers, etc.

FIGS. 2 through 4 shows structures of barrier ribs used in the conventional PDP. FIG. 2 shows a case where barrier ribs 21 (21 for each) are arranged in a stripe type on a lower dielectric layer 13b on a rear glass 20, wherein the barrier ribs 21 orthogonally intersect scan electrodes (not shown) and sustain electrodes (not shown), each consisting of a bus electrode and a transparent electrode. Such a stripe type of the barrier ribs 21 can be manufactured by a simple process, and facilitates interaction with address electrodes (not shown) on the rear glass 20 since bus electrodes are exposed to discharge spaces. However, the stripe type has drawbacks, in that visible light generated by discharge is leaked in the stripe direction of the barrier ribs, wrong discharge causing adjacent cells to be discharged can be generated, the application proportion of phosphors is small although phosphors are easily printed and gas are easily exhausted, and, accordingly, luminous efficiency is low.

Meanwhile, FIG. 3 shows a case where barrier ribs 21 (21 for each) are arranged in a well type on a lower dielectric layer 13b on a rear glass 20. Referring to FIG. 3, the barrier ribs 21 are arranged in a horizontal or vertical direction with respect to scan electrodes (not shown) and sustain electrodes (not shown), each consisting of a transparent electrode and a bus electrode. Such a well type of barrier ribs can increase brightness and prevent cross-talk in all directions since the application area of phosphors in each discharge cell is wide. However, the well type requires a complicated manufacturing process and difficulty exists in discharging impurity gas to the outside during a gas discharge process in a PDP manufacturing process.

To improve the gas discharge characteristic in the well type structure of barrier ribs, conventionally, as shown in FIG. 4, a method of making a height difference between a first barrier rib 21a and a second barrier rib 21b partitioning discharge cells has been used. However, such a structure has a problem in that unstable discharge occurs due to a difference in permittivity between the first barrier rib 21a and the second barrier rib 21b partitioning the discharge cells, although the gas discharge characteristic of a PDP is improved. Furthermore, if bus electrodes constituting scan and sustain electrodes are disposed over barrier ribs in a row direction of a PDP, the bus electrodes cannot actively interact with address electrodes formed on a lower substrate, which deteriorates jitter characteristic. That is, reactive power, which is not available to drive an actual circuit, is generated between the address electrodes and the bus electrodes, thereby causing power loss.

### SUMMARY OF THE INVENTION

To solve these problems, the present invention provides a plasma display panel (PDP) and a manufacturing method thereof, capable of enhancing discharge characteristic as well as discharge characteristic and jitter characteristic, by improving the structure of barrier ribs of the PDP.

According to an aspect of the present invention, there is provided a plasma display panel (PDP) including: row ribs and column ribs with a height different from that of the row ribs, wherein a permittivity of higher ones of the row ribs and the column ribs is lower than that of lower ones of the row ribs and the column ribs.

The higher ones of the row ribs and the column ribs are the column ribs.

Black layers are formed on the higher ones of the row ribs and the column ribs.

According to another aspect of the present invention, there is provided a plasma display panel (PDP), including: discharge cells partitioned by row ribs and column ribs with a height different from that of the row ribs, wherein a permittivity of higher ones of the row ribs and the column ribs is lower than that of lower ones of the row ribs and the column ribs, and the higher ribs are made of at least two materials with different permittivities.

The row ribs and portions of the column ribs with the same height as the row ribs are made of a material with a first permittivity, and portions corresponding to a difference in height between the row ribs and the column ribs are made of a material with a second permittivity lower than the first permittivity.

The material with the second permittivity contains a black material.

The higher ones of the row ribs and the column ribs are the column ribs.

According to another aspect of the present invention, there is provided a method for manufacturing a plasma display panel (PDP), the PDP including discharge cells partitioned by row ribs and column ribs, wherein a method for forming the row ribs and the column ribs including: (a) spreading a paste for the row ribs and the column ribs_on a dielectric layer formed on a glass;

(b) forming a pattern for the row ribs and the column ribs on the paste for the row ribs and the column ribs; and

(c) forming a rib material having a permittivity lower than that of the paste for the column ribs, with a predetermined height on the column ribs.

Row ribs and column ribs created by forming a pattern using the paste for forming the row ribs and the column ribs have the same height.

The forming of the material with the permittivity lower than that of the paste for forming the row ribs and the column ribs with a predetermined height on the column ribs, is performed by direct patterning.

The direct patterning is one of an inkjet method and a dispensing method.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a conventional plasma display panel (PDP);

FIGS. 2 through 4 show structures of barrier ribs used in the conventional PDP;

FIG. 5 is a perspective view showing a structure of barrier ribs of a PDP according to a first embodiment of the present invention;

FIG. 6 is a perspective view showing a structure of barrier ribs of a PDP according to a second embodiment of the present invention;

FIGS. 7A and 7E are views for sequentially explaining a method for manufacturing the barrier ribs of the PDP according to the second embodiment of the present invention;

FIG. 8 is a graph representing jitter characteristic appearing in an address period when the PDPs according to the first and second embodiments of the present invention are driven; and

FIG. 9 is a graph representing brightness characteristic according to discharge occurring in an address period when the PDPs according to the first and second embodiments of the present invention are driven.

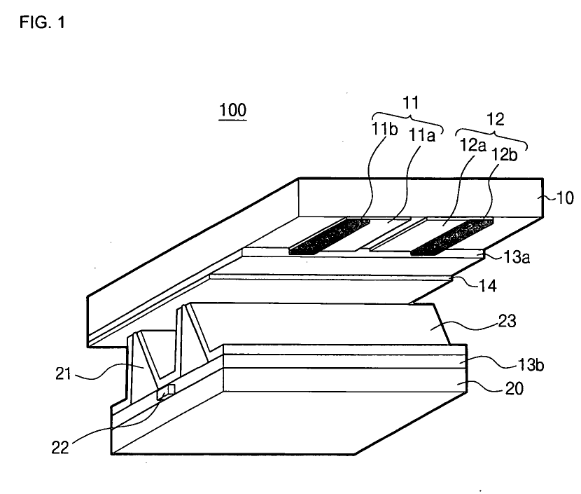

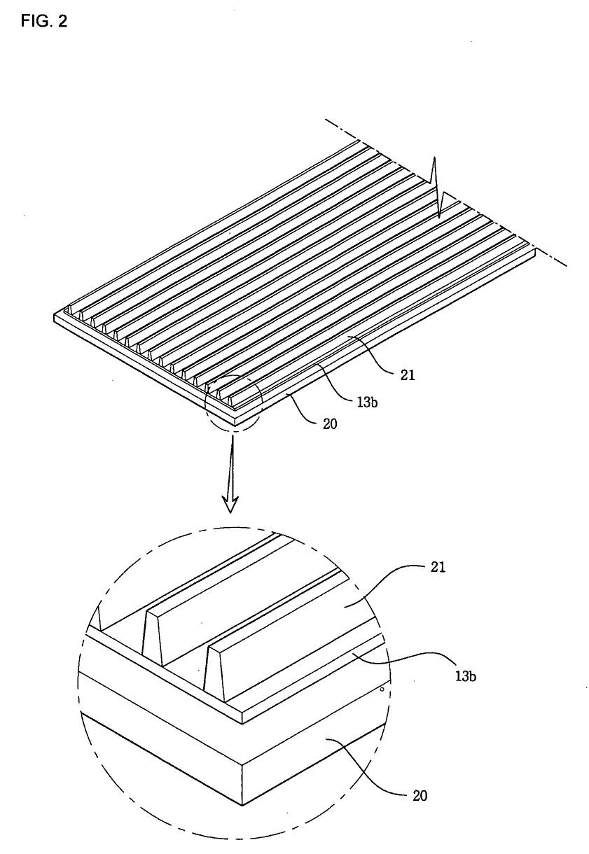

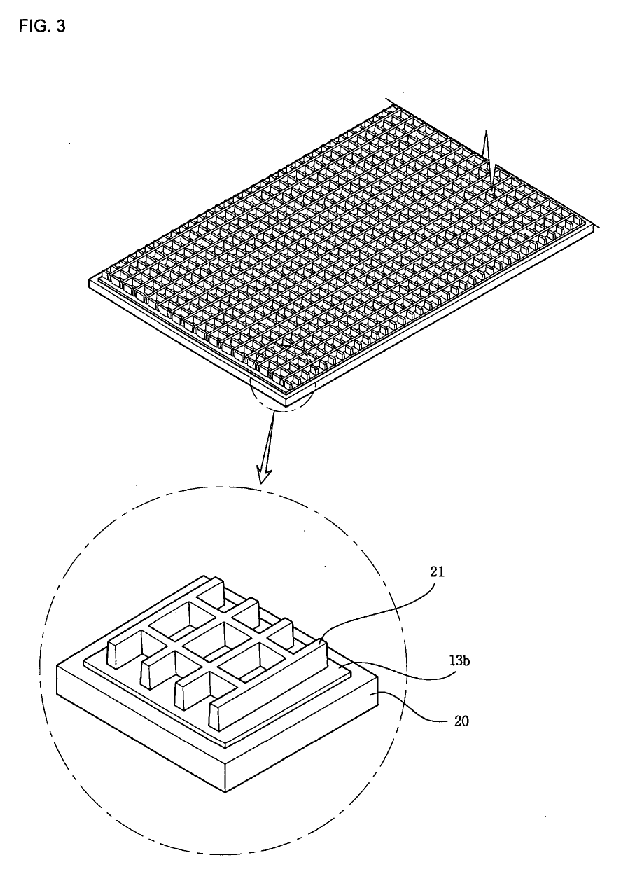

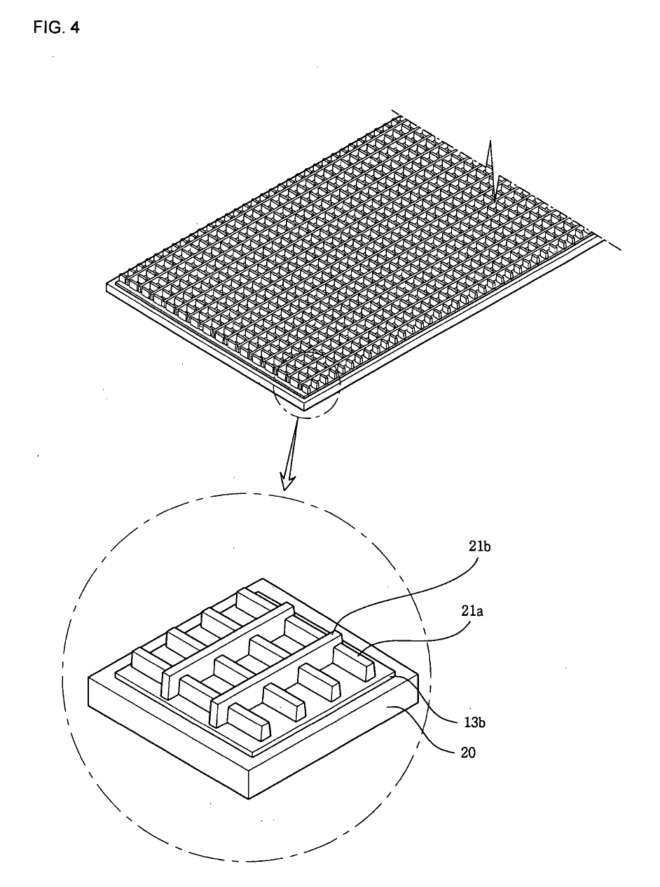

### DETAILED DESCRIPTION OF THE INVENTION

Hereinafter, preferable embodiments of the present invention will be described in detail with reference to the appended drawings.

### First Embodiment

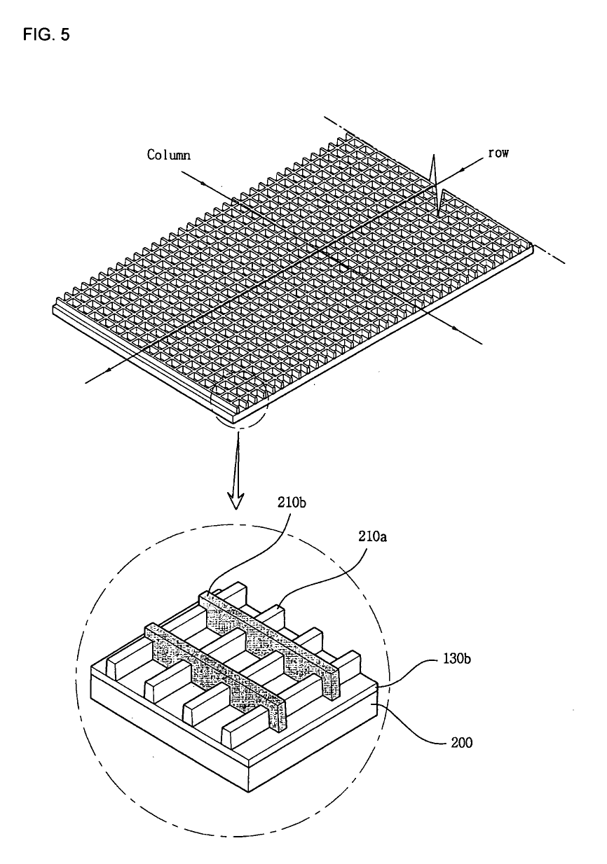

FIG. 5 is a perspective view showing a structure of barrier ribs of a plasma display panel (PDP) according to a first embodiment of the present invention.

As not shown in FIG. 5, in the PDP according to the first embodiment of the present invention, a front substrate being a display plate on which images are displayed is coupled spacing by a predetermined distance with a rear substrate being the rear plate of the PDP, like a convention PDP.

In the front substrate, sustain electrodes, each consisting of a pair of a scan electrode and a sustain electrode, are formed on a front glass. A upper dielectric layer is formed on the front glass on which scan electrodes and sustain electrodes are parallely arranged, to limit discharge current. Also, a MgO layer as a protection layer is formed on the upper dielectric layer, to prevent the upper dielectric layer from being damaged due to sputtering caused by plasma discharge and accelerate the generation of secondary electrons.

In the rear substrate, address electrodes are formed on a rear glass in a manner to intersect the sustain electrodes parallely arranged on the front glass. A lower dielectric layer is formed to cover the upper surfaces of the address electrodes, in order to accumulate wall charges. Also, barrier ribs partitioning discharge cells are formed on the lower dielectric layer. Phosphor layers are formed in spaces formed by the discharge cells so that visible light with one of red (R), green (G), and blue (B) is emitted.

Referring to FIG. 5, in the PDP constituted as described above, barrier ribs are formed in a well type such that row ribs 210a (210a for each) and column ribs 210b (210b for each) formed on a lower dielectric layer 130b on a rear glass 200 partition discharge cells. The row ribs 210a have a height different from the column ribs 210b. Here, the row ribs 210a and the column ribs 210b are respectively made of materials with different permittivities, however, the total permittivity of the row ribs 210a is the same as that of the column ribs 210b. That is, as the higher ones of the row ribs 210a and the column ribs 210b are made of a material with a permittivity lower than that of the relatively lower ones, the total permittivity of the row ribs 210a is the same as that of the column ribs 210b. Here, the row ribs 210a are barrier ribs for partitioning a discharge space in which one of R, G, and B phosphors is formed into unit pixels, and the column ribs 210b are barrier ribs for separately dividing and partitioning R, G, and B phosphors into unit pixels in a discharge space in which the R, G, and B phosphors are formed.

The higher ones of the row ribs 210a and the column ribs 210b are made of Frit Glass (conventionally used) containing PbO, Al₂O₃, and other oxides. The relatively lower ones of the row ribs 210a and the column ribs 210b are made of PbO or other oxides excluding oxides with a high permittivity such as TiO₂. Here, in order to improve the contrast characteristic of the PDP, black layers are preferably formed on the upper surfaces of the higher ones of the row ribs 210a and the column ribs 210b. The black layers may be made of the same material as a black matrix used for improving the contrast characteristic of a conventional front substrate.

Accordingly, in the PDP according to the first embodiment of the present invention, it is possible to prevent unstable discharge, such as abnormal discharge and wrong discharge, of discharge cells caused by a difference in permittivity between row ribs and column ribs with a height different from that of the row ribs.

However, although gas discharge characteristic and discharge characteristic are improved by making a height difference between the row ribs 210a and the column ribs 210b as described above, when phosphors are applied to discharge cells partitioned by the row ribs 210a and the column ribs 210b, the phosphors can flow into non-desired adjacent discharge cells due to the viscosity of the phosphors so that the colors of the phosphors are mixed together. Therefore, it is preferable to form the column ribs 210b of separately dividing R, G, and B phosphors higher than the row ribs 210a.

In the PDP constituted as described above, according to the first embodiment of the present invention, the barrier ribs can be manufactured by Sand blasting or etching. Preferably, the barrier ribs are manufactured by Screen printing using a mask, considering that the barrier ribs are made of different materials.

### Second Embodiment

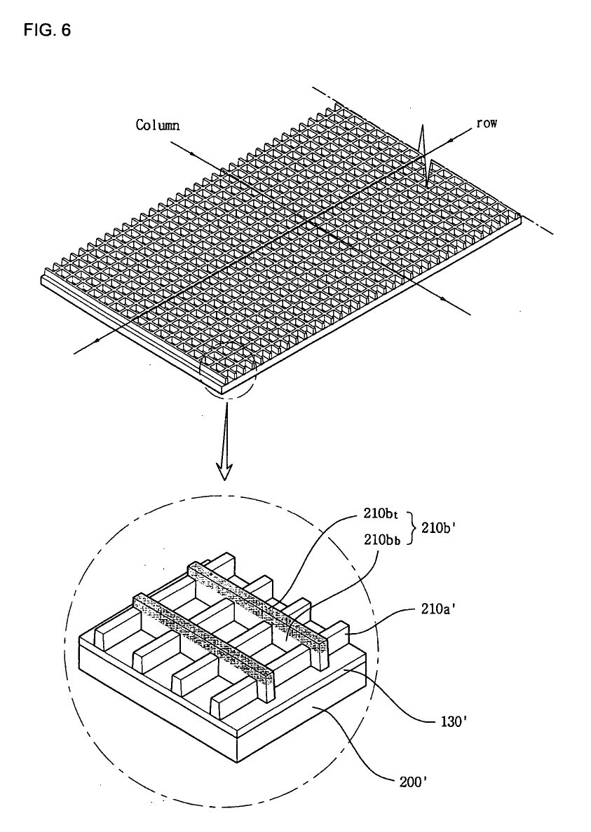

FIG. 6 is a perspective view showing a structure of barrier ribs of a PDP according to a second embodiment of the present invention. As not shown in the drawing, the PDP according to the second embodiment of the present invention has the same structure as the PDP according to the first embodiment of the present invention, except for that barrier ribs of the PDP according to the second embodiment of the present invention, as shown in FIG. 6, are formed in a well type such that row ribs 210a′ and column ribs 210b′ formed on a lower dielectric layer 130b′ on a rear glass 200′ partition discharge cells and the row ribs 210a′ have a height different from the column ribs 210b′. The row ribs 210a′ and the column ribs 210b′ are made of materials with different permittivities. That is, the higher ones of the row ribs 210a′ and the column ribs 210b′ have a permittivity lower than that of the relatively lower ones. The higher ones are made of at least two materials with different permittivities.

Preferably, the row ribs 210a′ and the portions 210b_{b} of the column ribs with the same height as the row ribs 210a′, which are formed toward the upper dielectric layer (not shown) on the lower dielectric layer 130b′ on which barrier ribs are formed, are made of a material with a first permittivity. The portions 210bₜ of the column ribs, which are disposed higher than the row ribs 210a′, are made of a material with a second permittivity lower than the first permittivity. The reason is to simplify a process and improve process yield when barrier ribs are manufactured by a PDP manufacturing method to be described later. The material with the first permittivity is Frit Glass (conventionally used) containing PbO, Al₂O₃, and other oxides. The material with the second permittivity lower than the first permittivity is PbO or other oxides excluding oxides with a high permittivity such as TiO₂. Here, a black material is preferably contained in the barrier ribs with the second permittivity, in order to improve the contrast characteristic of the PDP. The black material may be the same material as a black matrix used for improving the contrast characteristic of the front substrate. Accordingly, in the PDP according to the second embodiment of the present invention, it is possible to improve contrast characteristic as well as to prevent unstable discharge, such as abnormal discharge and wrong discharge, of discharge cells caused by a difference in permittivity between row ribs and column ribs, when the PDP where the row ribs are formed with a height different from that of the column ribs is driven.

Meanwhile, as described above, although discharge characteristic and gas discharge characteristic are improved by making a height difference between row ribs and column ribs as described above, when phosphors are applied to discharge cells partitioned by the row ribs and the column ribs, the phosphors can flow into non-desired adjacent discharge cells due to the viscosity of the phosphors so that the colors of the phosphors are mixed together.

Therefore, like the first embodiment of the present invention, it is preferable to form the column ribs 210b′ of separately dividing R, G, and B phosphors higher than the row ribs 210a′ in discharge spaces where the R, G, and B phosphors are applied.

The PDP according to the present invention includes a driving unit (not shown) for driving the PDP. The structure of barrier ribs formed on the PDP has been described above.

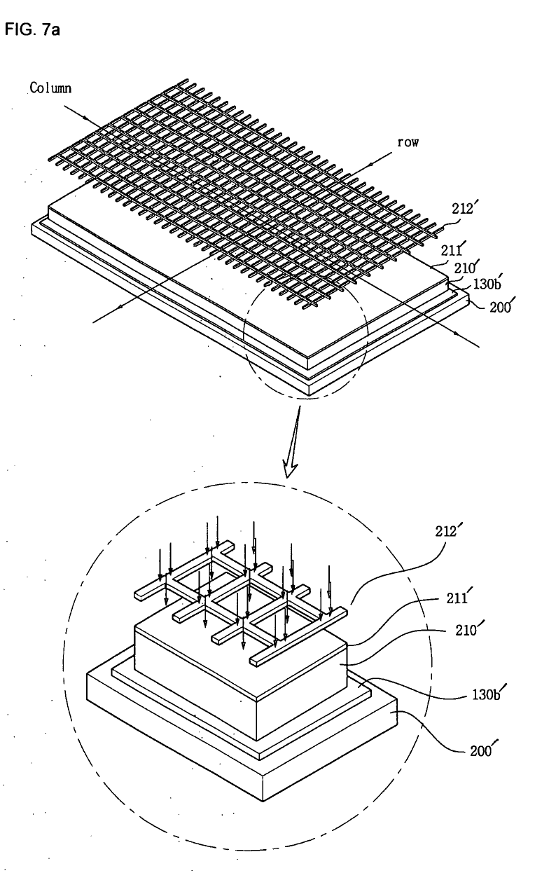

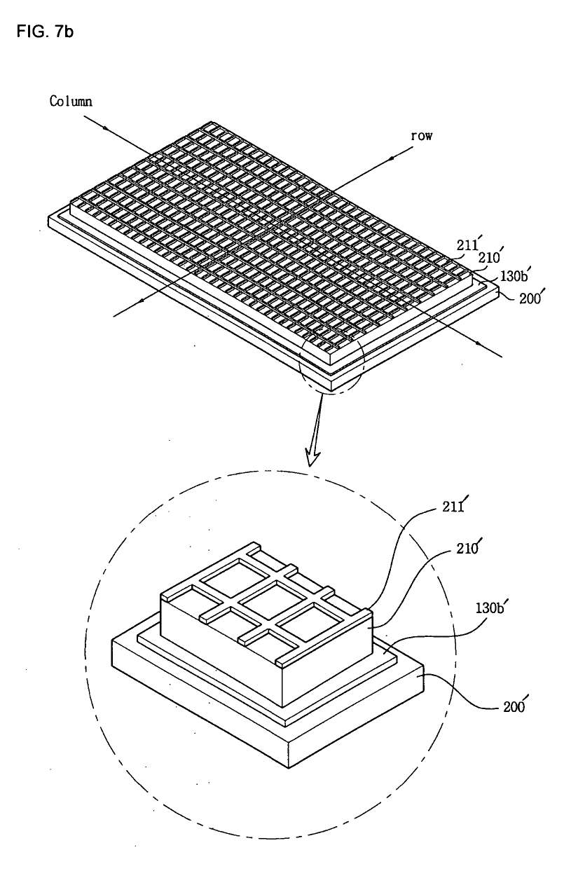

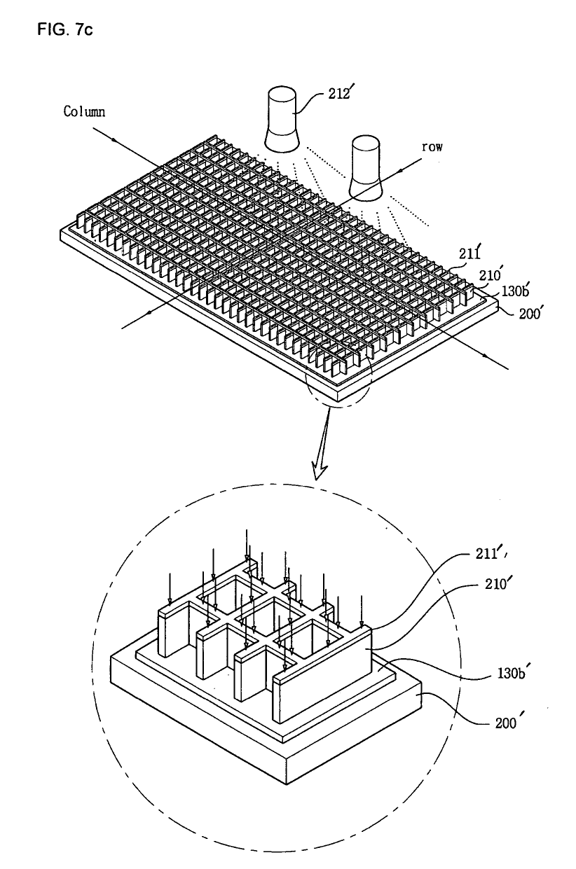

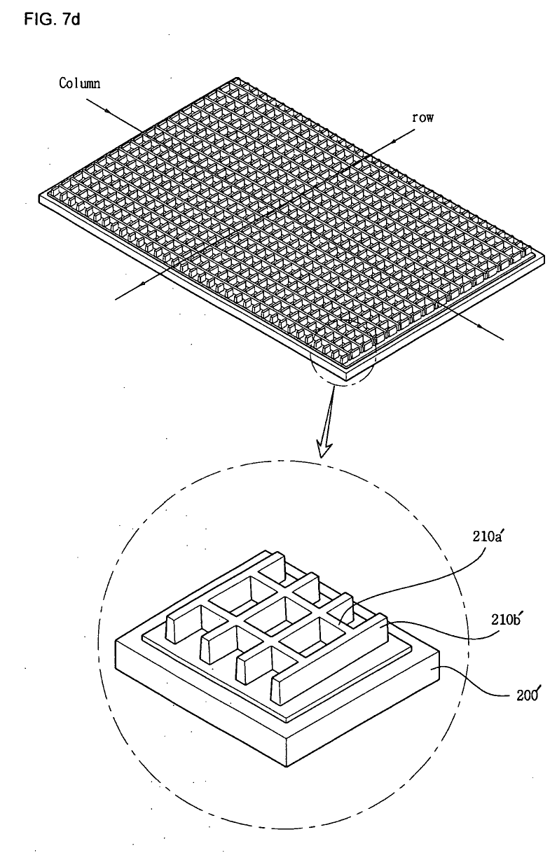

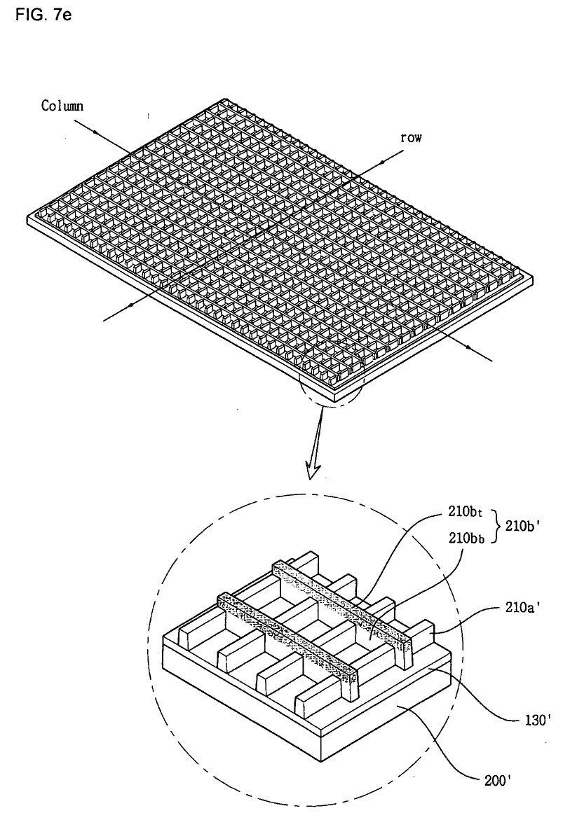

According to a method for manufacturing the PDP according to the second embodiment of the present invention, a process of forming barrier ribs will be described with reference to FIGS. 7A through 7E.

FIGS. 7A and 7E are views for sequentially explaining a method for manufacturing the barrier ribs of the PDP according to the second embodiment of the present invention.

First, as shown in FIG. 7A, a lower dielectric layer 130b′ is formed on a rear glass 200′ on which electrodes (not shown) are packaged and a paste for forming barrier ribs with a predetermined thickness is formed on the lower dielectric layer 130b′ by printing or coating, etc. Then, a Dry Film Resin (hereinafter, referred to as DFR) 211′ is formed by laminating, etc. on the paste for forming the barrier ribs and a photo mask 212′ with a predetermine pattern is arranged on the DFR to perform a exposure process of radiating light such as UV.

Then, as shown in FIG. 7B, after the exposure process is performed on the DFR 211′, a developing process is performed. By the developing process, a portion (hereinafter, referred to as a ‘non-exposed area’) of the DFT 211′ not exposed to the light remains on the paste 210′ for forming the barrier ribs, while a portion (hereinafter, referred to as a ‘exposed area’) of the DFR 211′ exposed to the light is etched and removed.

Thereafter, as shown in FIG. 7C, a Sand blasting apparatus 212′ is placed and driven over the DFR 211′ and the paste 210′ for forming the barrier ribs, so to spray sand particles to the paste 210′ for forming the barrier ribs. Thus, the paste 210′ for forming the barrier ribs is etched due to sputtering of the sand particles, except for a portion of the paste 210′ corresponding to barrier ribs, protected by the pattern of the DFR 211′.

Then, as shown in FIG. 7D, an etching process is performed on the barrier ribs 210′ formed by being protected by the DFR 211′, thus forming row ribs 210a′ and column ribs 210b′ with the same height.

The row ribs 210a′ and the column ribs 210b′ according to the present invention are formed in a predetermined pattern by forming the DFR on the paste for forming the barrier ribs and performing an exposure process on the DFR, as shown in FIGS. 7A through 7D. However, it is also possible to form row ribs and column ribs by adding a photosensitive material to the paste for forming the barrier ribs and performing an exposure process. That is, a pattern consisting of row ribs and column ribs can be formed by an arbitrary process capable of forming a pattern, as well as by an exposure process.

Then, as shown in FIG. 7E, a material 210bₜ with a permittivity lower than the column ribs 210b_{b} is formed with a predetermined height on the column ribs 210b_{b} by direct patterning. Here, the direct patterning is to directly apply a paste for forming barrier ribs to the upper surfaces of barrier ribs through a nozzle of an inkjet apparatus or a nozzle of a dispensing apparatus, without forming a pattern using a subsidiary means such as a pattern mask as in screen printing. Accordingly, as a method of forming barrier materials with a lower permittivity on column ribs, direct patterning, preferably, an inkjet method, a dispensing method, and screen printing. can be used.

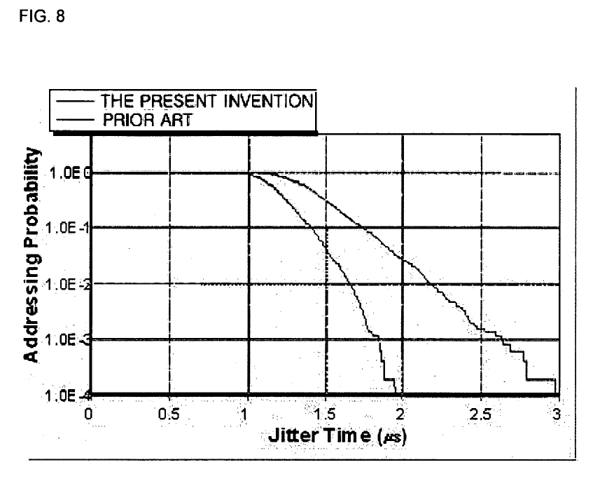

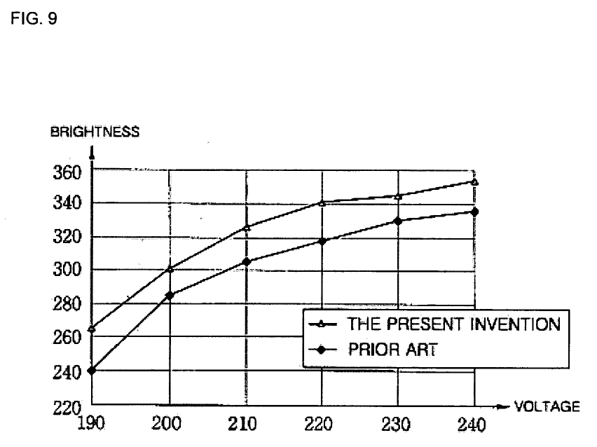

FIG. 8 is a graph representing jitter characteristic appearing in an address period when the PDPs according to the first and second embodiments of the present invention are driven. FIG. 9 is a graph representing brightness characteristic according to discharge occurring in an address period when the PDPs according to the first and second embodiments of the present invention are driven. As seen in FIGS. 8 and 9, in the PDPs according to the first and second embodiments of the present invention, jitter characteristic in an address period or brightness characteristic appearing when address discharge is performed, are improved. Accordingly, contrast characteristic is improved.

As described above, according to the present invention, it is possible to improve gas discharge characteristic and jitter characteristic causing reactive power and reduce power loss, by improving the structure of barrier ribs of a PDP.

Also, it is possible to improve brightness when address discharge is performed while a PDP is driven, thus improving the contrast of the PDP.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel (PDP) comprising:
a row rib and a column rib with a height different from that of the row rib,
wherein a permittivity of higher ones of the row rib and the column rib is lower than that of lower one of the row rib and the column rib.

2. The PDP as claimed in claim 1, wherein the column rib is higher than the row rib.

3. The PDP as claimed in claim 1 or 2, wherein black layers are formed on the higher one of the row rib and the column rib.

4. A plasma display panel (PDP) comprising:
discharge cells partitioned by row ribs and column ribs with a height different from that of the row ribs,
wherein a permittivity of higher ones of the row ribs and the column ribs is lower than that of lower ones of the row ribs and the column ribs, and
the higher ribs are made of at least two rib materials with different permittivities.

5. The PDP as claimed in claim 4, wherein the row ribs and portions of the column ribs with the same height as the row ribs are made of a rib material with a first permittivity, and
portions corresponding to a difference in height between the row ribs and the column ribs are made of a rib material with a second permittivity lower than the first permittivity.

6. The PDP as claimed in claim 5, wherein the rib material with the second permittivity includes a black material.

7. The PDP as claimed in claim 4 or 5, wherein the column ribs are higher than the row ribs.

8. A plasma display apparatus comprising:
row ribs and column ribs with a height different from that of the row ribs,
wherein a permittivity of higher ones of the row ribs and the column ribs is lower than that of lower ones of the row ribs and the column ribs.

9. The plasma display apparatus as claimed in claim 8, wherein the column ribs are higher than the row ribs.

10. The plasma display apparatus as claimed in claim 8 or 9, wherein black layers are formed on the higher ones of the row ribs and the column ribs.

11. A. plasma display apparatus, comprising:
discharge cells partitioned by row ribs and column ribs with a height different from that of the row ribs,
wherein a permittivity of higher ones of the row ribs and the column ribs is lower than that of lower ones of the row ribs and the column ribs, and
the higher ribs are made of at least two rib materials with different permittivities.

12. The plasma display apparatus as claimed in claim 11, wherein the row ribs and portions of the column ribs with the same height as the row ribs are made of a material with a first permittivity, and
portions corresponding to a difference in height between the row ribs and the column ribs are made of a rib material with a second permittivity lower than the first permittivity.

13. The plasma display apparatus as claimed in claim 12, wherein the rib material with the second permittivity includes a black material.

14. The plasma display apparatus as claimed in claim 11 or 12, wherein the column ribs are higher than the row ribs.

15. A method for manufacturing a plasma display panel (PDP) including discharge cells partitioned by row ribs and column ribs, comprising the steps of:
(a) spreading a paste for the row ribs and the column ribs_on a dielectric layer formed on a glass;
(b) forming a pattern for the row ribs and the column ribs on the paste for the row ribs and the column ribs; and
(c) forming a rib material having a permittivity lower than that of the paste for the column ribs, with a predetermined height on the column ribs.

16. The method as claimed in claim 15, wherein the row ribs and the column ribs created by the pattern on the paste have the same height.

17. The method as claimed in claim 15, wherein the forming of the rib material, having the permittivity lower than that of the paste for the row ribs and the column ribs, with a predetermined height on the column ribs, is performed by a direct patterning method.

18. The method as claimed in claim 17, wherein the direct patterning method is one of an inkjet method and a dispensing method.
